(19) United States
(12) Patent Application Publication
(10) Pub. No.: US 2020/0366037 A1
(43) Pub. Date: Nov. 19, 2020

(54) WALL RETRACTABLE CHARGER

(71) Applicant: Phillip Candella, Toledo, OH (US)

(72) Inventor: Phillip Candella, Toledo, OH (US)

(21) Appl. No.: 16/905,022

(22) Filed: Jun. 18, 2020

Related U.S. Application Data
(63) Continuation-in-part of application No. 16/412,832, filed on May 15, 2019.

(51) Int. Cl. H01R 13/72; H01R 13/717; H01R 24/60; H01R 25/00; H02G 11/02; H02J 7/00

(52) U.S. Cl. CPC H01R 13/72; H01R 13/7175; H01R 24/60; H01R 2103/00; H02G 11/02; H02J 7/0042; H01R 25/006

(57) ABSTRACT

An outlet mounted to a wall with a retractable USB charging cable is presented. The outlet for providing access for portable electronic devices is presented. The outlet is useful when a person has left their charger, either forgetfully or by lending to a friend, for their portable device. The outlet provides a charging capability without having to remember bringing the charging cable with the portable device. The outlet has a face plate, an AC/DC port, a plate lead screw, a portable device charging port and an actuator. The outlet is preferably made of a hard-plastic material but other materials are contemplated such as, but not limited to, aluminum, metal, titanium, high-density polyethylene (HDPE), etc. The outlet is preferably of a rectangular shape but other shapes are contemplated such as, but not limited to, round, square, trapezoidal, etc. The outlet box has electrical wires including a ground wire, a retractor assembly and a cable with a cable guard. The outlet provides a light emitting diode (LED) lamp for illuminating the outlet for ease of use.

### PRIORITY

This utility application is a continuation-in-part application of U.S. patent application Ser. No. 16/412,832, filed on May 15, 2019, the entirety of the application is hereby incorporated by reference.

### FIELD OF THE INVENTION

This invention relates to electrical outlets. More particularly, it relates to retractable chargers for an electrical outlet.

### BACKGROUND

AC power plugs and sockets connect electric equipment to the alternating current (AC) power supply in buildings and at other sites. Electrical plugs and sockets differ from one another in voltage and current rating, shape, size, and connector type. Different standard systems of plugs and sockets are used around the world.

Plugs and sockets for portable appliances became available in the 1880s, to replace connections to light sockets with wall-mounted outlets. A proliferation of types developed for both convenience and protection from electrical injury. Today there are about 20 types in common use around the world, and many obsolete socket types are found in older buildings. Coordination of technical standards has allowed some types of plug to be used across large regions to facilitate trade in electrical appliances, and for the convenience of travelers and consumers of imported electrical goods.

Some multi-standard sockets allow use of several types of plug; improvised or unapproved adaptors between incompatible sockets and plugs may not provide the full safety and performance of an approved socket-plug combination.

A plug is the movable connector attached to an electrically operated device, and the socket is fixed on equipment or a building structure and connected to an energized electrical circuit. The plug is a male connector with protruding pins that match the openings and female contacts in a socket. Some plugs have female contacts that are used only for an earth ground connection. Some plugs have built-in fuses for safety.

To reduce the risk of electric shock, plug and socket systems have safety features in addition to the recessed contacts of the energized socket. These may include plugs with insulated sleeves, recessed sockets, or automatic shutters to block socket apertures when a plug is removed.

A socket may be surrounded by a decorative or protective cover [symbol] which may be integral with the socket.

Single-phase sockets have two current-carrying connections to the power supply circuit, and may also have a third pin for a safety connection to earth ground. Depending on the supply system, one or both current-carrying connections may have significant voltage to earth ground.

With the popular use of rechargeable devices such as phones, tablets and computer laptops, a cable for charging the device must always be carried with the user. This is tedious and prone to forgetfulness. Therefore, there is a need for a charger for these devices to reside permanently for use in recharging the devices.

### BRIEF DESCRIPTION OF THE DRAWINGS

FIG. 1A is an illustrated view of an exemplary outlet.

FIG. 1B is an illustrated view of a second embodiment of the exemplary outlet shown in FIG. 1A.

FIG. 2 is an illustrated internal view of the exemplary outlet shown in FIG. 1A and FIG. 1B.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

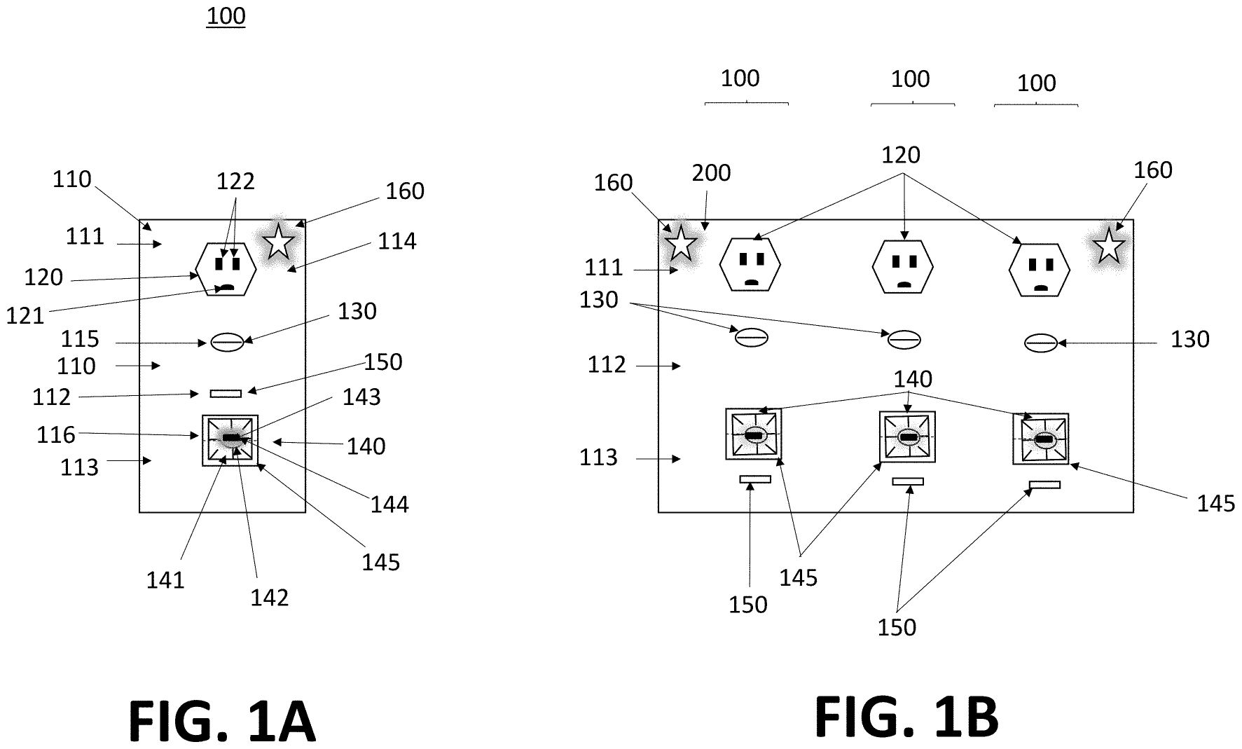

Referring to FIG. 1A and FIG. 1B, an illustrated view of an exemplary outlet 100 for providing access for portable electronic devices is presented. The outlet 100 is useful when a person has left their charger, either forgetfully or by lending to a friend, for their portable device. The outlet 100 provides a charging capability without having to remember bringing the charging cable with the portable device. The outlet 100 provides a light emitting diode (LED) lamp for illuminating the outlet for ease of use.

The outlet 100 has a face plate 110, an AC/DC port 120, one or more plate lead screws 130, one or more portable device charging ports 140, one or more lights 160 and an actuator 150. The outlet 100 is preferably made of a hard-plastic material but other materials are contemplated such as, but not limited to, aluminum, metal, titanium, high-density polyethylene (HDPE), etc. The outlet 100 is preferably of a rectangular shape but other shapes are contemplated such as, but not limited to, round, square, trapezoidal, etc. The one or more lights 160 are preferably light emitting diodes lamps, however other types of lamps are hereby contemplated, including, but not limited to, pen light, etc. The number of charging ports 140 is preferably one but it is contemplated that more than one charging ports 140 are coupled to the face plate 110.

The outlet 100 is preferably between three and one-half to four (3.5-4) inches in height but other heights are contemplated such as, but not limited to, five (5) inches, two (2) inches, ten (10) inches, etc.

The outlet 100 preferably has a length of between two and two and one-half (2-2.5) inches but other lengths are contemplated such as, but not limited to, five (5) inches, one (1) inch, ten (10) inches, etc.

The outlet 100 preferably has a width of between two and one-half and three (2.5-3) inches but other lengths are contemplated such as, but not limited to, five (5) inches, two (2) inches, ten (10) inches, etc.

The face plate 110 has an upper portion 111, a middle portion 112 and a lower portion 113. The electric port 120 is coupled to a first opening 114 in the upper portion of the face plate 110. The AC/DC port 120 is preferably has a ground port 121 and a two plug ports 122. The AC/DC port 120 supplies energy from the two plug ports 122 to an electrical device. The ground port 121 is a safeguard when the electrical current is too high for the electronic device or lightning strikes and causes a spike in the electrical current. The face plate 110 is preferably of a single outlet 100 size, but other sizes are contemplated such as, but not limited to, two (2) outlets, three outlets (200) of FIG. 1B., etc. The one or more lights 160 are coupled to the face plate 110.

The plate lead screws 130 couple the face plate 110 to an electrical box (not shown in FIG. 1A or FIG. 1B). The plate lead screws 130 are threaded through a second opening 115 of the face plate 110 preferably in the upper portion 111 and the lower portion 113 of the face plate 110. The plate lead screws 130 is preferably a Philips head screw, but other screw heads are contemplated such as, but not limited to, Allen wrench head screw, flat head screw, etc.

The portable device charging port 140 is coupled to a third opening 116 of the face plate 110 of the outlet 100. The portable device charging port 140 is preferably square in shape, but other shapes are contemplated such as, but not limited to round, oblong, rectangular, etc. The portable device charging port 140 has a grommet 141 and charging head 143. The charging head 143, in FIG. 1B, each of the portable device charging ports 140 may be designated for a different charging head 143 such as a first charging head being for an apple device (lightening), a second charging head being for android device (USB micro), etc. The charging head 143 may, optionally and/or additionally, a light 144. The light 144 is preferably a light emitting diode (LED) lamp. The charging head 143 may have a protective cover 145, Optionally and/or additionally, the charging head 143 may not have a protective cover. The protective cover 145 is preferably foldable such that the charging head 143 is accessible without fully removing the protective cover 145.

The grommet 141 is preferably flexible but may be rigid. Optionally and/or additionally, the grommet 141 has a stopper 142 is preferably made of a rubber material, but other materials have been contemplated such as, but not limited to, plastic, vinyl, etc. The stopper 142 preferably prevents the charging head 143 from retracting behind the face plate 110. The charging head 143 is preferably a lightening connector, but other adapters are contemplated such as, but not limited to, USB-C, USB micro, USB-A, USB-B, etc.

The actuator 150 is preferably a push button but may be any other type of actuator. The actuator 150 when pressed retracts a cable coupled to the charging head 143 and thereby bring the charging head 143 to rest upon the stopper 142.

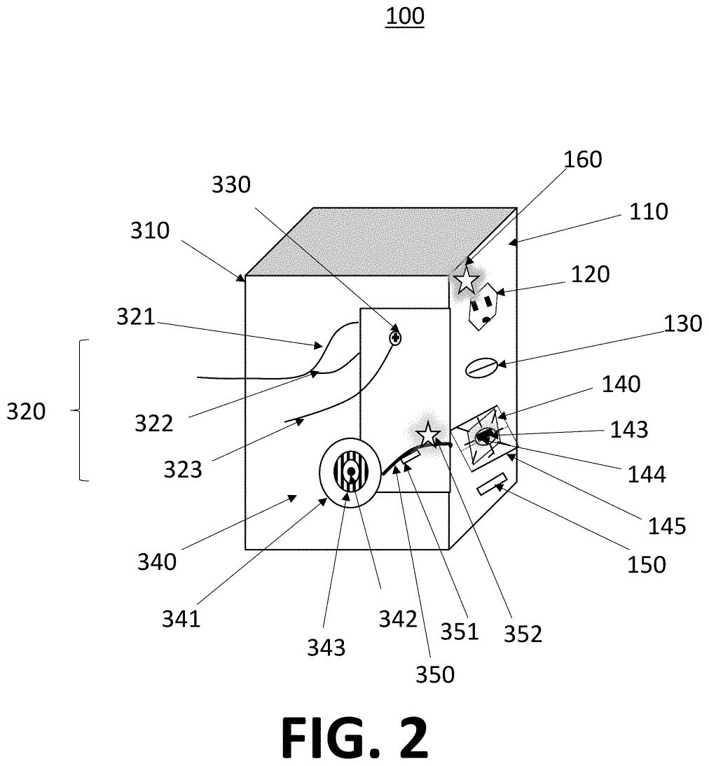

Moving now to FIG. 2, an illustrated internal view of the exemplary outlet 100 shown in FIG. 1A and FIG. 1B is presented.

The outlet 110 has a work box 310, a power wire 320, a ground screw 330, a retractor assembly 340, one or more lights 360 and a cable 350. The work box 310 is useful for containing the parts in a safe and secure location such as to avoid fires, rodents, screws or nails driven through the wall, etc. The work box 310 is preferably made of a metal material but other materials are contemplated such as, but not limited to, such as high-density polyethylene (HDPE), hard plastic, etc. The one or more lights 160 are preferably light emitting diodes lamps, however other types of lamps are hereby contemplated, including, but not limited to, pen light, etc. The one or more lamps 160 are coupled to the face plate 110. Additionally, and/or optionally, the cable 350 may have a lamp 352. The lamp 352 is preferably a light emitting diode (LED) cable.

The power wire 320 is useful for providing power to the outlet 100. The power wire 320 has a hot wire 321, a common wire 322 and a ground wire 323. The ground wire 323 is coupled to the ground screw 330.

The retractor assembly 340 is useful for maintaining the cable 350 such that it can be pulled out or retracted without being tangled. The retractor assembly 340 has a pully 341, an axle 342, a retractor wheel 343. The pully 341 eases the operation of the retractor assembly by reducing the effort used to extract or retract the cable 350. The pully 341 is preferably a spring-loaded pully, but may be any other type of pully.

The axle 342 is coupled to the pully 341 and the retractor wheel 343. The axle 342 provides a central fulcrum for the retractor wheel 343 to rotate. The retractor wheel 343 provides storage of the cable 350.

The cable 350 extends from the retractor assembly 340 and coupled to the charging head 143. The cable 350 further is coupled to a cord feed support 351 which when in use provides support for feeding the cable 350 to the retractor assembly 340 when being retracted or feeding the cable 350 to the outlet 100 when being extracted. The cable 350 preferably having a length of two (2) feet, but other lengths of cable are contemplated such as, but not limited to, four (4) feet, six (6) feet, ten (10) feet, twelve (12) feet, twenty (20) feet, etc. The charging head 143 may, optionally and/or additionally, a light 144. The light 144 is preferably a light emitting diode (LED) lamp. The charging head 143 may have a protective cover 145. The protective cover 145 is preferably foldable such that the charging head 143 is accessible without fully removing the protective cover 145.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (22) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An outlet mounted to a wall, the outlet comprising:
a face plate, the face plate having a plurality of openings;
a cable extending from the face plate;
a retractor assembly, wherein the retractor assembly being interior to an electrical box and wherein the retractable assembly having a cable, the cable coupled to the charging end;
one or more lights, the one or more lights coupled to the face plate, the cable and the charging end;
one or more charging ports, the charging ports being coupled to the face plate, wherein each of the charging ports having a protective cover; and
an actuator, the actuator coupled to the retractable assembly, wherein when the actuator being actuated, the retractable assemble retracts the cable.

2. The outlet of claim 1, wherein the light being a light emitting diode (LED) lamp.

3. The outlet of claim 1, wherein the protective cover being foldable.

4. The outlet of claim 1, further comprising an AC/DC port.

5. The outlet of claim 1, wherein the outlet having a height of between three and one-half and four (3.5-4) inches.

6. The outlet of claim 1, wherein the outlet having a length of between two and two and one-half (2-2.5) inches.

7. The outlet of claim 1, wherein the outlet having a depth of between two and one-half and three (2.5-3) inches.

8. The outlet of claim 1, wherein the outlet having a rectangular shape.

9. The outlet of claim 1, wherein the outlet being made out of a hard-plastic material.

10. The outlet of claim 1, wherein the plate screw being a phillips head screw.

11. The outlet of claim 1, wherein the cable being two (2) feet in length.

12. The outlet of claim 1, wherein the cable being four (4) feet in length.

13. The outlet of claim 1, wherein the cable being six (6) feet in length.

14. The outlet of claim 1, wherein the charging end being for an apple device (lightening).

15. The outlet of claim 1, wherein the charging end being for an android device (USB micro).

16. The outlet of claim 1, wherein the outlet having a plurality of charging ends, and wherein the outlet having a plurality of cables.

17. The outlet of claim 16, wherein each of the plurality of charging ends being different.

18. The outlet of claim 1, face plate further comprising:
a plurality of openings;
a grommet coupled to a first of the plurality of openings, the grommet being a port for the cable and the charging end; and
the grommet having a stopper, wherein the stopper being for preventing the charging end from retracting behind the face plate.

19. The outlet of claim 1, wherein the retractor assembly further comprising:
a pully;
a retractor wheel, the retractor wheel for holding the cable;
an axle, the axle movably coupled to the pully, wherein the axle rotates the retractor wheel and wherein the axle prevents the pully from movement; and
the retractor wheel holding the cable wherein the cable being easily extracted when the cable being retracted.
